(19) United States
(12) Patent Application Publication
(10) Pub. No.: US 2026/0187874 A1
(43) Pub. Date: Jul. 2, 2026

(54) MODIFYING VIRTUAL BACKGROUND IMAGE TO AVOID DUPLICATION FOR REALISTIC VIDEO COMMUNICATION SESSIONS

(71) Applicant: MOTOROLA MOBILITY LLC, WILMINGTON, DE (US)

(72) Inventors: AMIT KUMAR AGRAWAL, BANGALORE (IN); RAHUL Bharat DESAI, Hoffman Estates, IL (US)

(21) Appl. No.: 19/007,841

(22) Filed: Jan. 2, 2025

(51) Int. Cl. G06T 11/60; H04L 65/403

(52) U.S. Cl. CPC G06T 11/60; H04L 65/403; G06T 2200/24

(57) ABSTRACT

An electronic device provides a more realistic composite video feed for a video communication session by triggering a change to a virtual background image (VBI) that is not duplicative of a VBI being used by another participant. A processor of the electronic device receives a video stream from an image capturing device positioned to capture a user of the electronic device during the video communication session. The processor detects a virtual background setting of the VCA for the video communication session selecting a first VBI of a plurality of VBIs in a memory. In response to determining that a second composite video image received, via a communications subsystem, from a second electronic device of one or more second electronic device matches the first VBI, the processor triggers a change from the first VBI to a second VBI that is not being used by any of the second electronic device(s).

### BACKGROUND

### 1. Technical Field

The present disclosure relates generally to electronic devices that support person-to-person(s) communication, and more particularly to electronic devices that support real-time person-to-person video communication.

### 2. Description of the Related Art

Electronic communication devices such as smartphones, tablets, laptops and desktop workstations enable users to participate in person-to-person(s) communication. To better emulate an in-person communication session, the electronic device may be configured to share a video of a corresponding user via a communication network to other second electronic device(s) to present to corresponding second user(s). Although the user may choose to share his image, in many instances the user may not want to reveal an actual image of what is visible around the user. In an example, the user may prefer to present a more professional decor or to make an individual statement with a selection of a virtual background image. Video conferencing modules that facilitate the video communication session enable extracting a user image that is superimposed onto the selected virtual background image for presenting on the electronic device and second electronic device(s).

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices, according to one or more embodiments;

FIG. 2 illustrates a further block diagram of the electronic device configured to trigger selection of a virtual background image that is not being used by another participate in a video communication session to create a more realistic composite video feed, according to one or more embodiments;

FIG. 3A illustrates a first virtual background image that may be used by another participant in a video communication session, according to one or more embodiments;

FIG. 3B illustrates a second virtual background image that is a unique, altered version of the first virtual background image of FIG. 3A generated by image horizontal mirroring, according to one or more embodiments;

FIG. 3C illustrates a third virtual background image that is a unique, altered version of the first virtual background image of FIG. 3A generated by image recoloring and horizontal mirroring, according to one or more embodiments;

FIG. 3D illustrates a fourth virtual background image that is a unique, altered version of the first virtual background image of FIG. 3A generated by superimposing additional image features, according to one or more embodiments;

FIG. 4 illustrates a display of the electronic device presenting a virtual background selection window as part of a video communication setup user interface, according to one or more embodiments;

FIG. 5A illustrates a display of the electronic device presenting a video communication session window with a first composite video feed of a user image and a virtual background selection window recommending a change to a second virtual background image that is not being currently used by another participant in a video communication session, according to one or more embodiments;

FIG. 5B illustrates the display of the electronic device presenting the video communication session window with a realistic composite video after a selection of the recommended virtual background image, according to one or more embodiments;

FIGS. 6A-6B (collectively “FIG. 6”) are a flow diagram presenting a computer-implement method for automatically selecting a virtual background image that is not being used by another participant in a video communication session, according to one or more embodiments; and

FIG. 7 is a flow diagram presenting a computer-implement method that augments the method of FIG. 6 by using image analysis to find matching virtual background images and by using image alteration to create a unique virtual background image, according to one or more embodiments.

### DETAILED DESCRIPTION

According to aspects of the present disclosure, an electronic device, a method and a computer program provide various techniques for presenting a more realistic composite video feed by triggering a change to a virtual background image that is not being used by another participant in the video communication session. Usage of video communication has become common-place and is used in all industries. In the corporate world, use of video communications provides significant savings on travel costs and time for in-person meetings, while providing a more connected experience compared to phone calls, even for one-on-one situations. Often, users prefer to set a predefined image as their background to mask their actual background and to present a professional appearance that is realistic. However, when the composite video is presented, the illusion of a realistic composite video is defeated when the virtual background image is already being used by another participant in the video communication session. Aspects of the present disclosure overcome this unrealistic duplication by either automatically switching or recommending switching to another virtual background image that is not duplicative. When no other virtual background images are available that are duplicative, the electronic device may further alter (e.g., horizontally mirror, recolor, add image features to, etc.) one of the existing virtual background images to generate an altered, unique version for use.

In one or more embodiments, the electronic device, method, and computer program product manage background images for users on a video call. The electronic device determines that the user is participating in a video conferencing session facilitated by a video communication application. The electronic device detects whether the user prefers to keep the camera turned on during the video conferencing application. Before the start of any video call or during a video communication session, the electronic device reviews all of the background image options and determines whether the currently selected virtual background image is duplicative of the virtual background image that is being used by at least one other participant in the video communication session. In one or more embodiments, after the first person joins the video call with the selected background image, the corresponding electronic device marks the background image being used as “already selected”. When any subsequent second user joins the video call with the same virtual background applied, the corresponding second electronic device prompts the second user to change the second user's virtual background if the background image has been marked as “already used” by another participant in the video call. This process continues as more people join the call or change their background image during the call. In an alternate embodiment, the video conferencing session is managed by a server computer, which controls the process of evaluating the background images and triggering change, to a new or altered background image, for a detected background image at any later-connected participant devices with a duplication of an existing (already-utilized) background image.

According to one or more embodiments, an electronic device has a memory including a video communication application (VCA) that has a plurality of virtual background images. The electronic device includes a communications subsystem that links the electronic device to a communication network. A processor of the electronic device is communicatively coupled to the memory and the communications subsystem. The processor executes the VCA to enable a video communication session between the electronic device and one or more second electronic device. The processor is further configured to cause the electronic device to receive a video stream from an image capturing device positioned to capture a user of the electronic device during the video communication session. The processor is further configured to cause the electronic device to detect a virtual background setting of the VCA for the video communication session selecting a first virtual background image of the plurality of virtual background images. In response to determining that a second composite video image received from a second electronic device among the one or more second electronic device matches the first virtual background image, the processor is further configured to cause the electronic device to trigger a change from the first virtual background image to a second virtual background image that is not being used by any of the one or more second electronic device.

According to one or more embodiments, a method provides a more realistic composite video feed by triggering a change to a unique, nonduplicative virtual background image. The method may include receiving a video stream from an image capturing device positioned to capture a user of an electronic device during a video communication session. The method may include detecting a virtual background setting for the video communication session selecting a first virtual background image of a plurality of virtual background images. In response to determining that a second composite video image received from a second electronic device among one or more second electronic device matches the first virtual background image, the method may include triggering a change from the first virtual background image to a second virtual background image that is not being used by any of the one or more second electronic device.

Further embodiments provide a computer program product that includes: a non-transitory computer readable medium; and program code on the computer readable medium that, when processed by a processor of an electronic device, configures the processor and/or the electronic device to perform functions of the above-described method.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent within the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized, and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

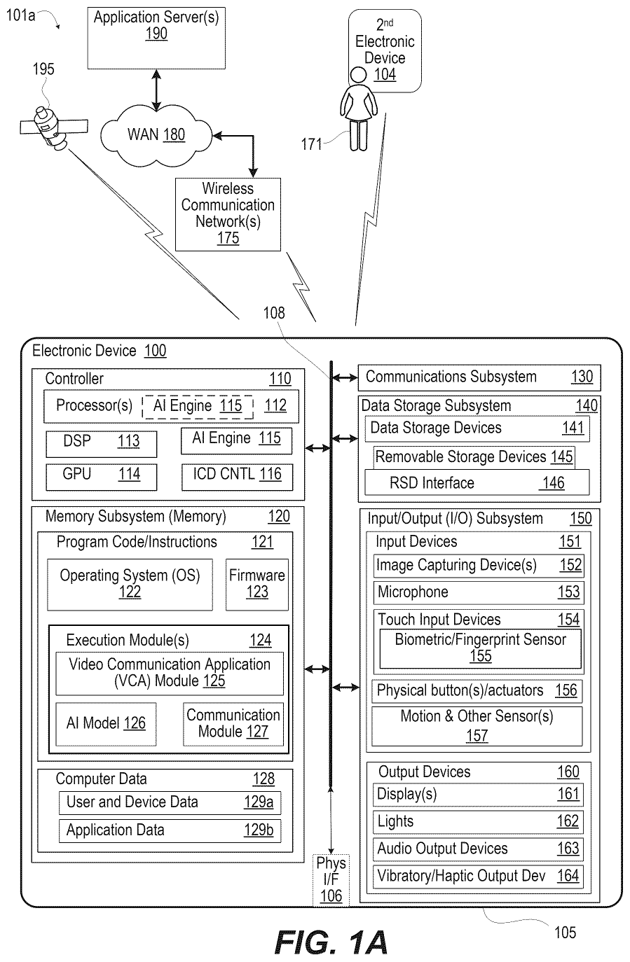

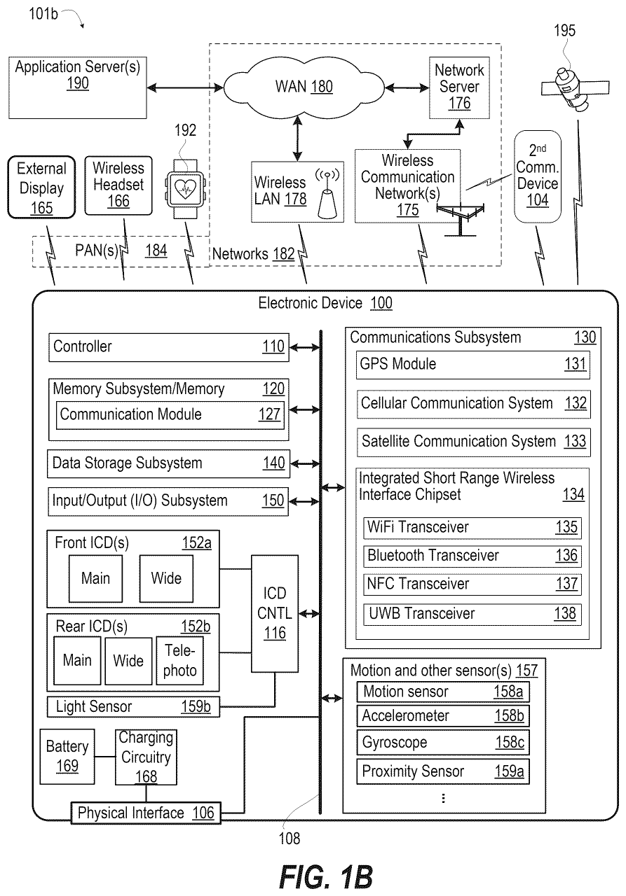

Those of ordinary skill in the art will appreciate that the hardware components and basic configuration depicted in the following figures may vary. For example, the illustrative components within electronic device 100 (FIG. 1A-1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, operational, or otherwise) on the described embodiments.

Referring now to the figures and beginning with FIG. 1A, there is illustrated a block diagram of an example electronic device 100 in communication environment 101a and having hardware and software components, which enable the features of the present disclosure to be advantageously implemented, according to one or more embodiments. Electronic device 100 provides implements various techniques for providing a more realistic composite video feed by triggering a change to a virtual background image that is unique and does not duplicate a background image that is being used by other electronic device(s) in a video communication session. Examples of electronic device 100 can include, but are not limited to, mobile devices, a notebook computer, a mobile phone, a smart phone, a digital camera with enhanced processing capabilities, a smart watch, a tablet computer, and other types of electronic devices. For purposes of this disclosure, electronic device is assumed to be a communication device that can be used to engage in a voice and/or video call with a second communication device. Electronic device 100 can therefore be interchangeably referred to herein as communication device 100.

Electronic device 100 generally includes controller 110, memory (or memory subsystem) 120, communication subsystem 130, data storage subsystem 140, input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more of operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113 graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown). Processor 112 can further include other processors such as auxiliary processor(s) that may act as a low power consumption, always-on sensor hub for physical sensors.

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122.

Memory subsystem (or memory) 120 may include a combination of volatile and non-volatile memory, such as random-access memory (RAM) and read-only memory (ROM). Memory subsystem 120 stores instruction or program code 121 for execution by processor 112 to configure processor 112 (and more generally electronic device 100) to provide the operational functions and features described herein. Instructions/program code 121 (or program code 121 for short) includes instructions for an operating system (OS) 122, firmware 123, such as basic input/output system (BIOS) or Uniform Extensible Firmware Interface (UEFI). Program code 121 includes execution module(s) 124 that collectively provides the various features of the disclosure. Execution module(s) 124 include, without limitation, video communication application (VCA) module 125, which provides the features and operating functionality of the disclosed embodiments when the corresponding program instructions of VCA module 125 are processed by/within processor 112/controller 110.

Execution modules 124 further includes AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within VCA module 125 and is trained to support the AI features of VCA module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, VCA module 125 can include program instructions that cause or configure processor 112 to cause electronic device 100 to trigger selection of a unique virtual background image for a video communication session. For another example, VCA module 125 can include program instructions that configure processor 112 to cause electronic device 100 to generate a unique virtual background image for selection when existing virtual background images are all being used by other electronic devices for the video communication session. Other features provided by VCA module 125 are described in further detail throughout this disclosure.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 104 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of VCA module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons/actuators 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detect movement of electronic device 100 and provide motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile, touch screen interface (154) can be utilized as an input device. The touch screen interface (154) can include one or more virtual buttons or selectable affordances. In one or more embodiments, when a user applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located on a rear surface of device housing 105. Other embodiments provide multiple integrated displays within electronic device 100 and references to display(s) 161 are assumed to refer to one or all of these multiple integrated displays.

Vibration/haptic output device 164 can cause electronic device 100 to vibrate or shake when activated. Vibration/haptic output device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101b. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101b that includes other devices.

Communications subsystem 130 includes global positioning system (GPS) module 131 that enables electronic device to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a Wi-Fi router of a wireless local area network (WLAN) 178 and/or second electronic device 104, via one or more short-range wireless interface(s). Second electronic device 104 can be a communication device, such as a smartphone, and/or can be similarly configured as electronic device 100. Second user 171 may operate second electronic device 104. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of VCA module 125 and/or access to other applications, online transactions, and resources. In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 192. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 192, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as an input/output data port and can be used as a power supply port that is coupled to charging circuitry 168 which feeds electrical power to device battery 169 to enable recharging of device battery 169 and/or powering of electronic device 100. As a data port, physical interface 106 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICD(s) can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image or iris scan recognition.

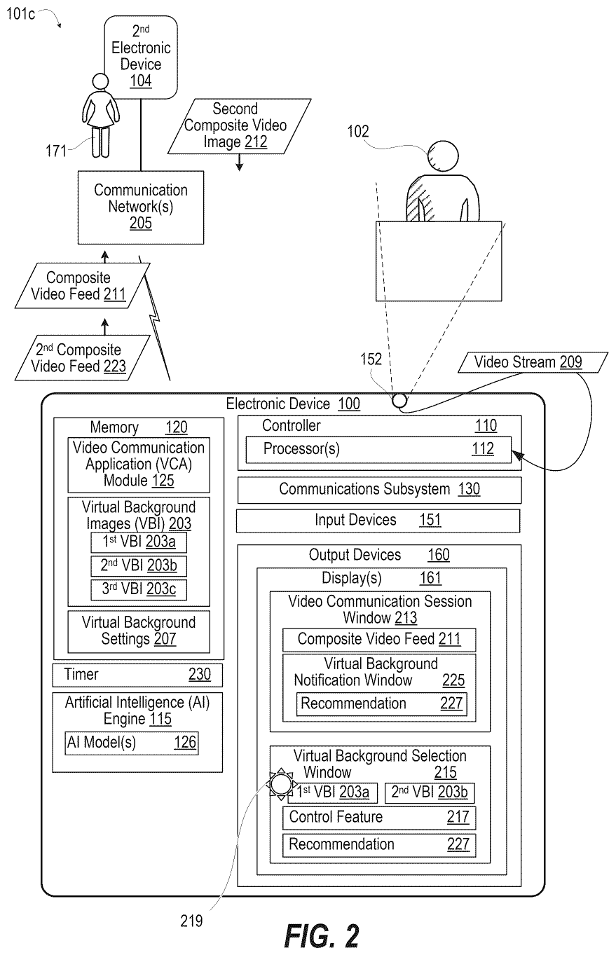

FIG. 2 illustrates a further block diagram of communication environment 101c with electronic device 100 configured to trigger selection/generation of a virtual background image for presenting a more realistic composite video feed by avoiding use of any virtual background image that is being used by another participant in the video communication session. According to aspects of the present disclosure, electronic device 100 has memory 120 including VCA module 125 having a plurality of virtual background images (VBIs) 203 (e.g., first VBI 203a and second VBI 203b). Electronic device 100 includes communications subsystem 130 that links electronic device 100 to communication network(s) 205 (e.g., wireless communication network(s) 175 of FIG. 1A or networks 182 of FIG. 1B). Processor 112 (FIG. 1A) is communicatively coupled to memory 120 and communications subsystem 130. Processor 112 executes VCA module 125 to enable a video communication session between electronic device 100 and one or more second electronic device 104. Processor 112 is further configured to cause electronic device 100 to detect virtual background settings 207 of VCA module 125 that selects first VBI 203a of the plurality of VBIs 203 for the video communication session. Processor 112 is further configured to cause electronic device 100 to receive video stream 209 from image capturing device 152 positioned to capture user 102 of electronic device 100 during the video communication session. In response to determining that a background image within a second composite video image(s) 212 received from second electronic device(s) 104 among the one or more second electronic device(s) matches first VBI 203a, trigger a change from first VBI 203a to second VBI 203b that is not being used by any of the one or more second electronic device 104. Instead of transmitting first composite video feed 211 that includes first VBI 203a, electronic device 100 transmits second composite video feed 223 that includes second VBI 203b.

In one or more embodiments, electronic device 100 includes one or more input device 151 that is communicatively coupled to processor 112. Electronic device 100 has one or more output device 160 including display 161 and that is communicatively coupled to processor 112. In triggering the change from first VBI 203a to second VBI 203b, processor 112 is configured to cause electronic device 100 to present, via display 161, virtual background selection window 215 containing recommendation 227 to select second VBI 203b to avoid duplicating use of first VBI 203a. Virtual background selection window 215 contains control feature 217 enabling selection of second VBI 203b by user 102 via one or more input device 151.

In one or more embodiments, in triggering the change in use from first VBI 203a to second VBI 203b, processor 112 is configured to cause electronic device 100 to automatically change first composite video image 211 from including first VBI 203a to second composite video feed 223 including second VBI 203b. In one or more embodiments, in triggering the change from first VBI 203a to second VBI 203b, processor 112 is configured to cause electronic device 100 to generate and render virtual background notification window 225 containing recommendation 227 for user 102 to select second VBI 203b. In response to determining that a change from using first VBI 203a to second VBI 203b has not occurred within a period of time following presentation of the recommendation, automatically change the composite image stream from the first virtual background image to the second virtual background image.

In one or more embodiments, processor 112 is configured to cause electronic device 100 to receive, via communications subsystem 130 from one or more second electronic device 104, information indicating use of first VBI 203a for a virtual background image. In one or more embodiments, processor 112 is configured to cause electronic device 100 to receive, via communications subsystem 130 from one or more second electronic device 104, second composite video image 212 containing a second user image overlayed/superimposed on first VBI 203a. Processor 112 is configured to cause electronic device 100 to compare VBI 203 of received second composite video image 212 to the plurality of VBIs 203. In an example, VBI 203 is to identified as first VBI 203a. Thus, first VBI 203a is being used by second user 171. To avoid duplicative, unrealistic use of first VBI 203a by electronic device 100 during the video communication session, processor 112 is configured to cause electronic device 100 to modify VBI 203 being used. In an example, electronic device 100 switches to a non-duplicative VBI 203 such as second VBI 203a. In another example, electronic device 100 alters VBI 203 to create non-duplicative VBI 203b.

In one or more embodiments, electronic device 100 includes artificial intelligence (AI) engine 115 trained to identify a background image in a video (e.g., second composite video image 212). Processor 112 is configured to cause electronic device 100 to identify a respective background image in each composite video image received respectively from the one or more second electronic device 104 using AI engine 115.

In one or more embodiments, processor 112 is configured to cause electronic device 100 to extract a video image of user 102 from video stream 209 from image capturing device 152. Processor 112 is configured to cause electronic device 100 to generate second composite video image 223 by overlaying the video image of the user on second VBI 203b. In one or more particular embodiments, electronic device 100 has one or more output device(s) 160, including display 161, communicatively coupled to processor 112. Processor 112 is configured to cause electronic device 100 to generate and render, via display 161, video communication session window 213 that includes first composite video image 211. In one or more particular embodiments, processor 112 is configured to cause electronic device 100 to transmit, via communications subsystem 130, first composite video image 211 to the one or more second electronic device 104 that generate and render, via a corresponding display, a video communication session window containing the first composite video image.

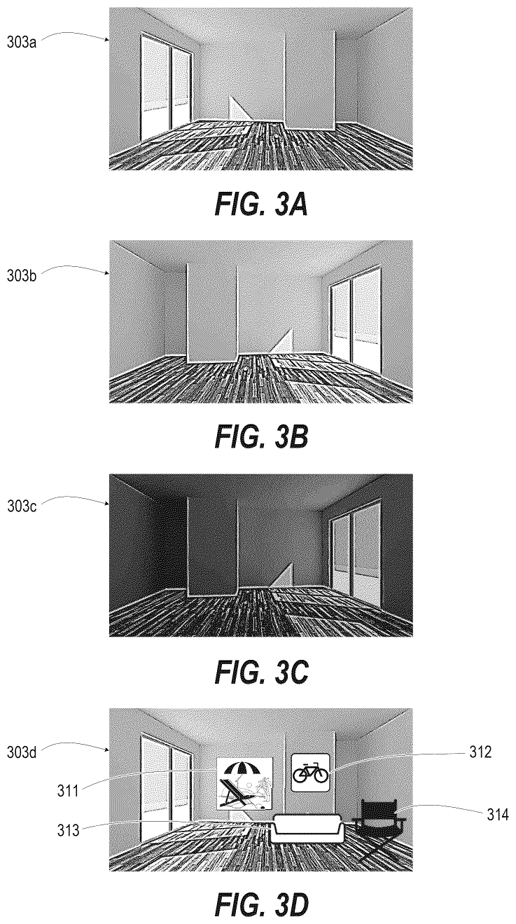

In one or more embodiments, electronic device 100 includes display 161 that is communicatively coupled to processor 112. In response to determining that each of the plurality of VBIs 203 in memory 120 are being used as VBI by the one or more second electronic device 104, processor 112 is configured to cause electronic device 100 to generate second VBI 203b via altering one of the plurality of VBIs 203. Specifically, processor 112 alters at least one image characteristic of one or more of the plurality VBI 203 in memory 120 from a group including: (i) color; (ii) horizontal mirroring; and (iii) focus. Examples are described below with regard to FIGS. 3A-3D. Processor 112 is configured to cause electronic device 100 to present, via display 161, virtual background selection window 215 containing a selection control (e.g., control feature 217) and second VBI 203b with an indication (e.g., annotation 219) that second VBI 203b does not duplicate a virtual background image being used by one of second electronic device(s) 104. The selection control enables user selection of second VBI 203b.

FIG. 3A illustrates example first virtual background image 303a that may be used by electronic device 100 (FIG. 1A) and may also be selected by another participant (e.g., second user 171) for use on corresponding second electronic device 104 in a video communication session with electronic device 100. In a situation in which electronic device 100 has no other available virtual background images to use that are not duplicative of those being used in the video communication session, electronic device 100 may generate a unique, non-duplicative virtual background image, such as depicted in FIGS. 3B, 3C, and 3D.

FIG. 3B illustrates second virtual background image 303b that is a unique, altered version of first virtual background image 303a of FIG. 3A generated by image horizontal mirroring. FIG. 3C illustrates third virtual background image 303c that is a unique, altered version of first virtual background image 303a of FIG. 3A generated by image recoloring and horizontal mirroring. FIG. 3D illustrates fourth virtual background image 303d that is a unique, altered version of first virtual background image 303a of FIG. 3A generated by superimposing additional image feature(s), such as beach picture 311, bicycle picture 312, couch 313, and director chair 314.

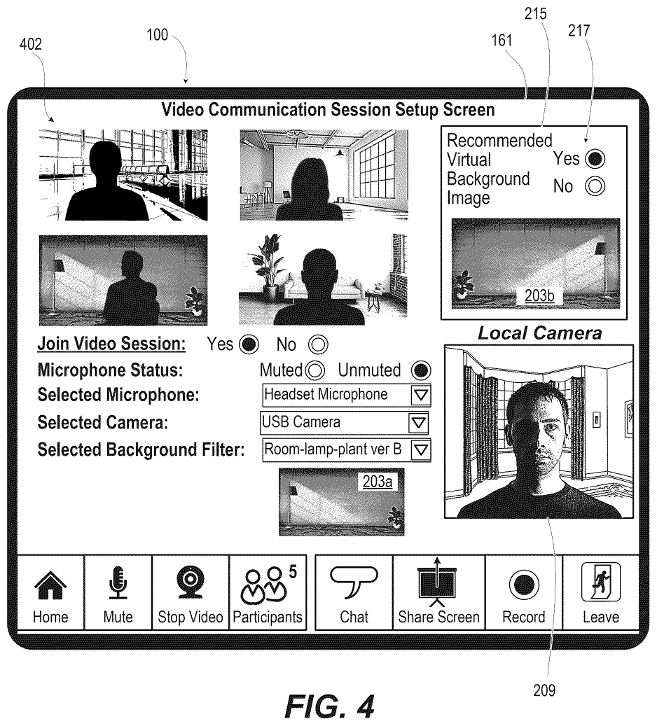

FIG. 4 illustrates an example display 161 of electronic device 100 presenting virtual background selection UI window 215 as part of video communication setup window 402. In an example, virtual background selection UI window 215 contains first virtual background image 203a and control feature 217 that enables selection of first VBI 203a by user 102.

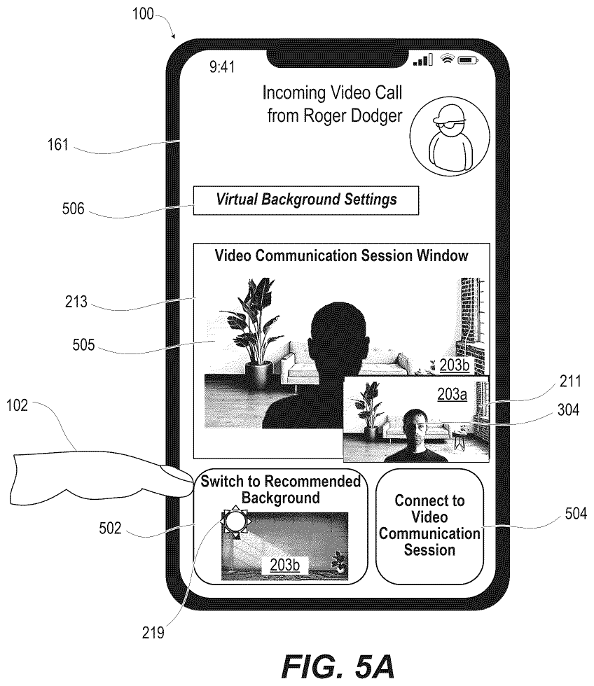

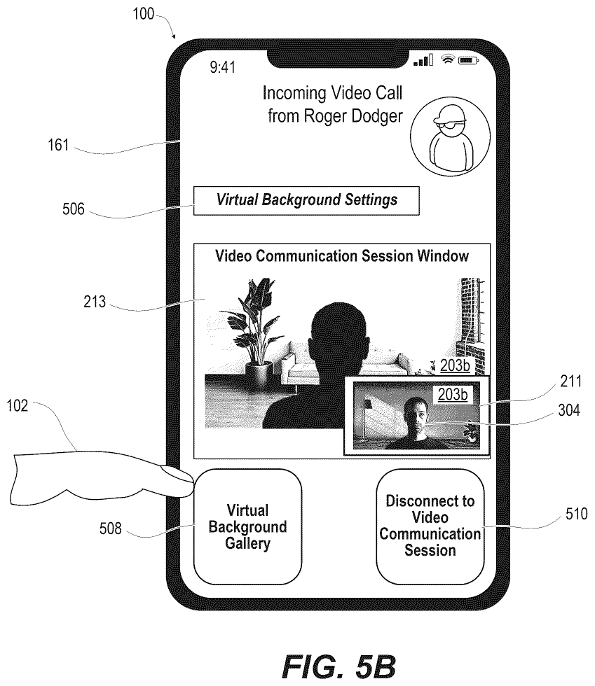

FIG. 5A illustrates display 161 of electronic device 100 presenting example virtual background selection UI window 215 recommending a change (within recommendation segment 502) in a selected virtual background image 203 (FIG. 2). Video communication session window 213 may be visible before triggering control 504 to connect/join a video communication session, showing composite video feed 505 that is being received from second communication device 104 (FIG. 2) along with a currently selected first composite video feed 211. Selected first composite video feed 211 will be transmitted if the user proceeds to join the communication session without a change in VBI 203. First composite video feed 211 is an unrealistic composite video of user 102 with first VBI 203a. Alternatively, video communication session window 213 may not be visible until the video communication session is connected/joined. Virtual background settings control 506 allows user to go to a more detailed setup screen, such as depicted and described with regard to FIG. 4. User 102 may interact with the detailed settings before joining or during the video communication session. In some situations, video communication session window 213 is presented during the video communication session. User 102 may trigger presentation of detailed settings. Alternatively, electronic device 100 may automatically present detailed settings when a need to change VBI 203 is detected. In some instances, such as an incoming call, user 102 may prefer an expedited selection of a virtual background image 203 (FIG. 2), such as just accepting recommendation 227 for second VBI 203b immediately followed by selecting control 504 to connect to the video communication session. As a first alternative to explicit acceptance accepting recommendation 227, electronic device 100 may automatically recommended second virtual background image 203b. As a second alternative to explicit acceptance or automatic acceptance, electronic device 100 may determine acquiescence to the change based on expiration of a period of time tracked by timer 230 (FIG. 2) since presenting a recommended second virtual background image 203b.

FIG. 5B illustrates display 161 of electronic device 100 presenting video communication session window 213 with realistic second composite video feed 223 of user image 304 superimposed on second virtual background image 203b after explicit user selection, automatic selection, or acquiescence to selection of the recommendation. Virtual background gallery control 508 allows the user to select a different virtual background image, each of which are respectively annotated as recommended or not. Disconnect control 510 facilitates ending or leaving the video communication session.

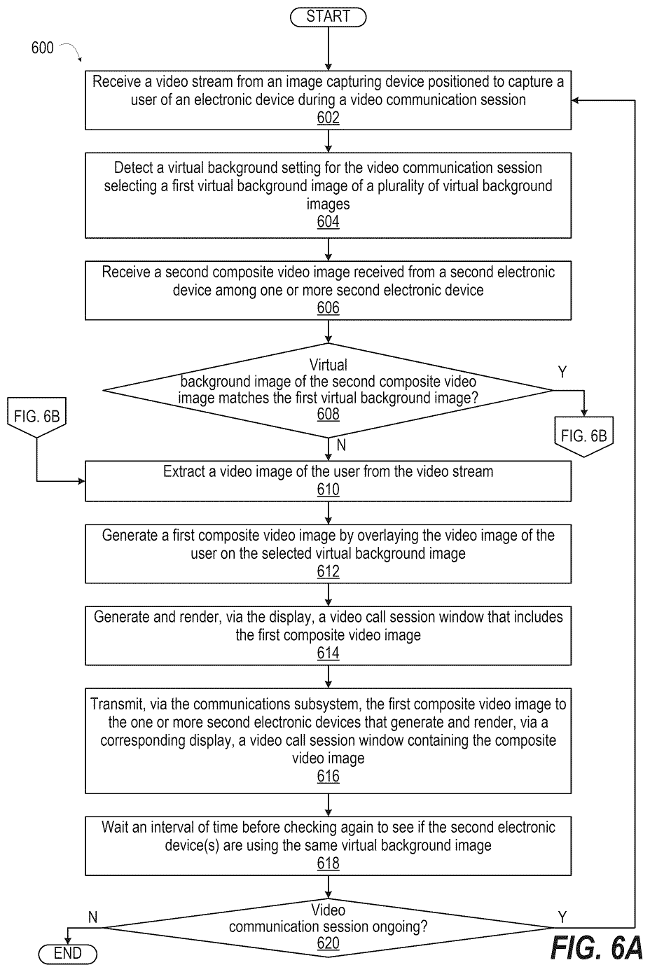

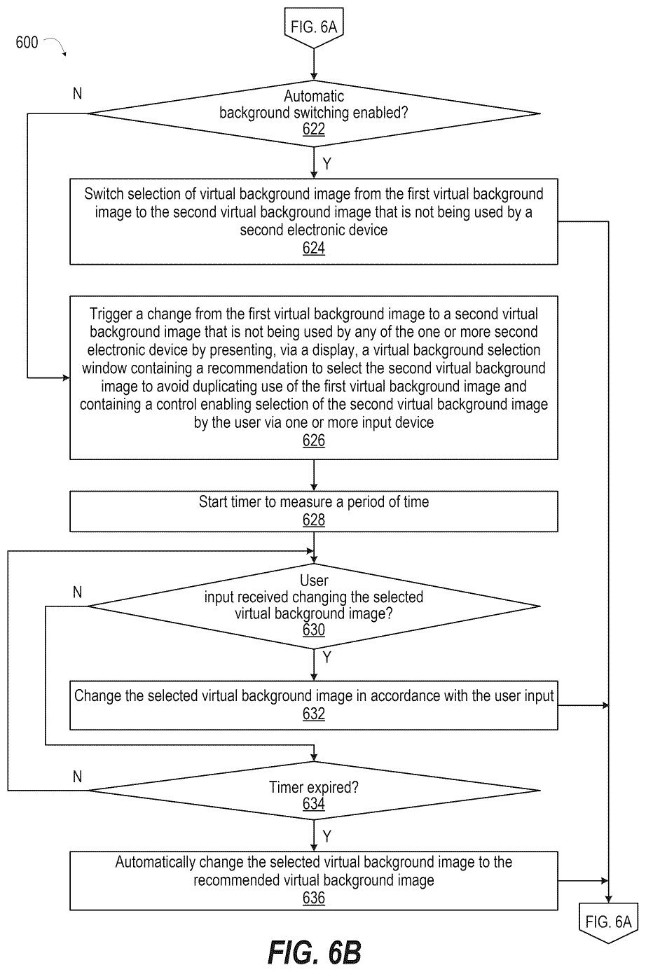

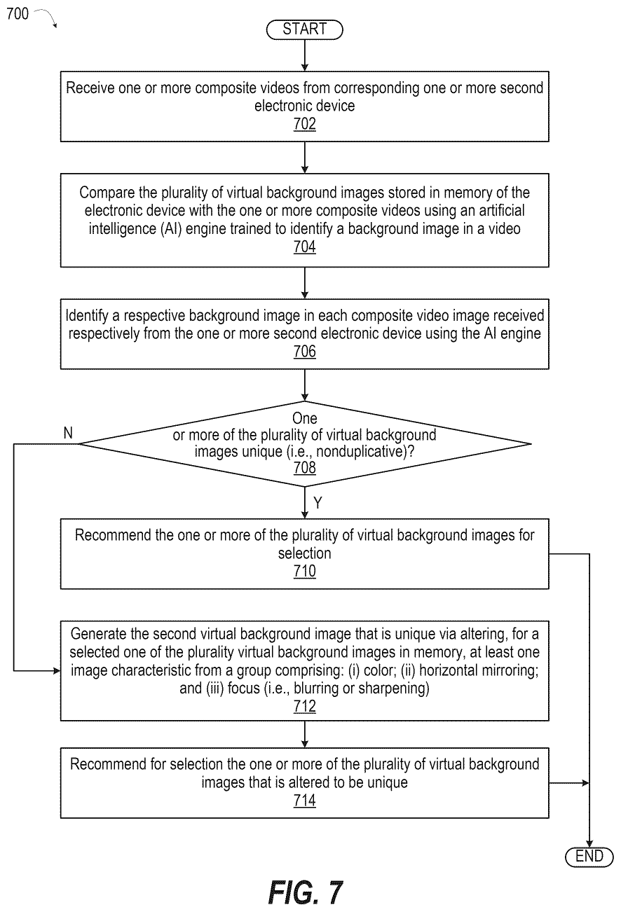

FIGS. 6A-6B (collectively “FIG. 6”) are a flow diagram presenting computer-implement method 600 for automatically selecting a virtual background image that is not being used by another participant in a video communication session. FIG. 7 is a flow diagram presenting computer-implement method 700 that augments method 700 of FIG. 6 by using image analysis to find matching virtual background images and by using image alteration to create a unique virtual background image. The descriptions of method 600 (FIG. 6) and method 700 (FIG. 7) are provided with general reference to the specific components illustrated within the preceding FIGS. 1A-1B, 2, 3A-3D, 4 , and 5. Specific components referenced in method 600 (FIG. 6) and method 700 (FIG. 7) may be identical or similar to components of the same name used in describing preceding FIGS. 1A-1B, 2, 3A-3D, 4 , and 5. In one or more embodiments, controller 110 (FIG. 1A) configures electronic device 100 (FIGS. 1A-1B) or a similar computing device to provide the described functionality of method 600 (FIG. 6) and method 700 (FIG. 7).

With reference to FIG. 6A, method 600 includes receiving a video stream from an image capturing device positioned to capture a user of an electronic device during a video communication session (block 602). Method 600 includes detecting a virtual background setting for the video communication session selecting a first virtual background image of a plurality of virtual background images (block 604). Method 600 includes receiving a second composite video image received from a second electronic device among one or more second electronic device (block 606). Method 600 includes determining whether a virtual background image of the second composite video image matches the first virtual background image (decision block 608). In one embodiment, method 600 can include exchanging information between the electronic device and the second electronic device(s) reserving one of the plurality of available virtual background images as the reserved background image is provisioned at each device. Alternatively, the electronic device may perform image analysis to identify whether the received composite video uses the same virtual background image. An example is described below with regard to method 700 (FIG. 7). In response to determining, in decision block 608, that the virtual background image of a second composite video image received from the second electronic device does match the first virtual background image, method 600 proceeds to decision block 622 (FIG. 6B) for determining whether automatic background switching is enabled.

With continuing reference to FIG. 6A, in response to determining that the virtual background image of a second composite video image received from the second electronic device does not match the first virtual background image, method 600 includes extracting a video image of the user from the video stream (block 610). Method 600 includes generating a first composite video image by overlaying the video image of the user on the selected virtual background image (block 612). Method 600 includes generating and rendering, via the display, a video communication session window that includes the first composite video image (block 614). Method 600 includes transmitting, via the communications subsystem, the first composite video image to the one or more second electronic device that generate and render, via a corresponding display, a video communication session window containing the composite video image (block 616). Method 600 includes waiting an interval of time before checking again to see if the second electronic device(s) are using the same virtual background image (block 618). Method 600 includes determining whether the video communication session is ongoing (decision block 620). In response to determining that the video communication session is ongoing, method 600 returns to block 602. In response to determining that the video communication session is not ongoing, method 600 ends.

In response to determining that the virtual background image of a composite video image received from a second electronic device matches the first virtual background image in decision block 608, with reference to FIG. 6B, method 600 includes determining whether automatic background switching is enabled (decision block 622). In response to determining that automatic background switching is enabled, method 600 includes switching selection of virtual background image from the first virtual background image to the second virtual background image that is not being used by a second electronic device (block 624). Then method 600 returns to block 610 (FIG. 6A). In response to determining that automatic background switching is not enabled (i.e., disabled), method 600 includes triggering a change from the first virtual background image to a second virtual background image that is not being used by any of the one or more second electronic device by presenting, via a display, a virtual background selection window containing a recommendation to select the second virtual background image to avoid duplicating use of the first virtual background image (block 626). According to one aspect, the selection window includes a control enabling selection of the second virtual background image by the user via one or more input device. Method 600 includes starting a timer to measure an elapsed period of time (block 628). Method 600 includes determining whether a user input is received that changes the selected virtual background image (decision block 630). In response to determining that the user input is received, method 600 includes changing the selected virtual background image in accordance with the user input (block 632). Then method 600 returns to block 610 (FIG. 6A). In response to determining that the user input is not received in decision block 630, method 600 includes determining whether the timer has expired (decision block 634). In response to determining that the timer has not expired, method 600 returns to block 630. In one or more embodiments, in response to determining that the timer has expired, method 600 includes automatically changing the selected virtual background image to the recommended virtual background image (block 636). Then method 600 returns to block 610 (FIG. 6A). In one or more alternative embodiments, method 600 includes not automatically changing the selected virtual background image to the recommended virtual background image (not shown).

With reference to FIG. 7, method 700 includes receiving one or more composite videos from corresponding one or more second electronic device (block 702). Method 700 includes comparing the plurality of virtual background images stored in memory of the electronic device with the one or more composite videos using an artificial intelligence (AI) engine trained to identify a background image in a video (block 704). Method 700 includes identifying, using the AI engine, a respective background image in each composite video image received respectively from the one or more second electronic device (block 706). Method 700 includes determining whether one or more of the plurality of virtual background images is unique (i.e., nonduplicative) by not being included in the one or more second composite video images (decision block 708). In response to determining that one or more of the plurality of virtual background images is unique, method 700 includes recommending the one or more of the plurality of unique virtual background images for selection (block 710). Then method 700 ends.

In response to determining, in decision block 708, that none of the plurality of virtual background images is unique, method 700 includes generating the second virtual background image that is unique via altering, for a select one of the plurality of virtual background images in memory, at least one image characteristic from a group comprising: (i) color; (ii) horizontal mirroring; and (iii) focus (i.e., blurring or sharpening) (block 712). Method 700 includes recommending for selection the virtual background image that has been altered to be unique (block 714). Then method 700 ends. In one embodiment, the processor alters more than one of the plurality of virtual background images or provides different alterations to a selected one virtual background image in order to provide the user with options to select from among.

According to aspects of the present disclosure, method 700 may include receiving a video stream from an image capturing device positioned to capture a user of an electronic device during a video communication session. Method 700 may include detecting a virtual background setting for the video communication session selecting a first virtual background image of a plurality of virtual background images. In response to determining that a second composite video image received from a second electronic device among one or more second electronic device matches the first virtual background image, method 700 includes triggering a change from the first virtual background image to a second virtual background image that is not being used by any of the one or more second electronic device.

In one or more embodiments, method 700 may further include triggering the change from the first virtual background image to the second virtual background image by presenting, via a display, a virtual background selection window containing a recommendation to select the second virtual background image to avoid duplicating use of the first virtual background image. In one embodiment, the virtual background selection window includes a control that enables selection of the second virtual background image by the user via one or more input device.

In one or more embodiments, method 700 may further include triggering the change from the first virtual background image to the second virtual background image by generating and rendering a virtual background notification window containing a recommendation for the user to select the second virtual background image. In response to determining that a change from using the first virtual background image to the second virtual background image has not occurred within a period of time following presentation of the recommendation, method 700 may further include automatically changing from the first virtual background image to the second virtual background image. In one or more embodiments, method 700 may further include receiving, via a communications subsystem of the electronic device from the one or more second electronic device, information indicating use by a second electronic device of the first virtual background image for a virtual background image.

In one or more embodiments, method 700 may further include receiving a second composite video image containing a second user image overlayed on the first virtual background image. Method 700 may further include comparing the virtual background image of the received composite video to the plurality of virtual background images to identify use of the first virtual background image by the second user.

In one or more embodiments, method 700 may further include extracting a video image of the user from the video stream. Method 700 may further include generating a first composite video image by overlaying the video image of the user on the second virtual background image. Method 700 may further include generating and rendering, via a display, a video communication session window that comprises the first composite video image. Method 700 may further include transmitting, via a communications subsystem of the electronic device, the first composite video image to the one or more second electronic device that generates and renders, via a corresponding display, a video communication session window containing the first composite video image.

In one or more embodiments, in response to determining that each of the plurality of virtual background images in a memory of the electronic device are being used as a virtual background image by the one or more second electronic device, method 700 may further include generating the second virtual background image via altering one of the plurality of virtual background images by altering for one or more of the plurality virtual background images in memory, at least one image characteristic from a group comprising: (i) color; (ii) horizontal mirroring; and (iii) focus. Method 700 may further include presenting, via a display, a virtual background selection window containing a selection control and the second virtual background image with an indication that the second virtual background image does not duplicate a virtual background image being used by one of the second electronic devices. The selection control enables user selection of the second virtual background image.

According to aspects of the present disclosure, the electronic device 100 (FIG. 1A), method 600 (FIG. 6), method 700 (FIG. 7), and computer program product, such as RSD 145 (FIG. 1A), provide techniques for presenting a more realistic composite video feed of a user against a virtual background image by triggering a change to a virtual background image that is unique and does not duplicate another virtual background image being used by a second electronic device during a video communication session. Among the benefits of the disclosure is that a user is able to present a more realistic and professional appearance by appearing to be a plausible real location presented in the video feed. In one of more embodiments, the electronic device automatically triggers a change in the virtual background image as other participants join the video communication session or change the corresponding virtual background image being used.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. An electronic device comprising:
a memory comprising a video communication application (VCA) comprising a plurality of virtual background images;
a communications subsystem that links the electronic device to a communication network; and
a processor communicatively coupled to the memory and the communications subsystem, and which executes the VCA to enable a video communication session between the electronic device and one or more second electronic device, the processor further configured to cause the electronic device to:
receive a video stream from an image capturing device positioned to capture a user of the electronic device during the video communication session;
detect a virtual background setting of the VCA for the video communication session selecting a first virtual background image of the plurality of virtual background images; and
in response to determining that a second composite video image received from a second electronic device among the one or more second electronic device matches the first virtual background image, trigger a change from the first virtual background image to a second virtual background image that is not being used by any of the one or more second electronic device.

2. The electronic device of claim 1, further comprising:
one or more output device comprising a display and communicatively coupled to the processor; and
one or more input device communicatively coupled to the processor; and
wherein, in triggering the change from the first virtual background image to the second virtual background image, the processor is configured to cause the electronic device to:
present, via the display, a virtual background selection window containing a recommendation to select the second virtual background image to avoid duplicating use of the first virtual background image and containing a control enabling selection of the second virtual background image by the user via the one or more input device.

3. The electronic device of claim 1, wherein, in triggering the change in use from the first virtual background image to the second virtual background image, the processor is configured to cause the electronic device to:
automatically change the first composite video image from including the first virtual background image to including the second virtual background image.

4. The electronic device of claim 1, wherein, in triggering the change from the first virtual background image to the second virtual background image, the processor is configured to cause the electronic device to:
generate and render a virtual background notification window containing a recommendation for the user to select the second virtual background image; and
in response to determining that a change from using the first virtual background image to the second virtual background image has not occurred within a period of time following presentation of the recommendation, automatically change from the first virtual background image to the second virtual background image.

5. The electronic device of claim 1, wherein the processor is configured to cause the electronic device to:
receive, via the communications subsystem from the one or more second electronic device, information indicating use of the first virtual background image for a virtual background image.

6. The electronic device of claim 1, wherein the processor is configured to cause the electronic device to:
receive a second composite video image containing a second user image overlayed on the first virtual background image; and
compare the virtual background image of the received second composite video image to the plurality of virtual background images to identify use of the first virtual background image by the second user.

7. The electronic device of claim 1, further comprising an artificial intelligence (AI) engine trained to identify a background image in a video, and wherein the processor is configured to cause the electronic device to identify a respective background image in each composite video image received respectively from the one or more second electronic device using the AI engine.

8. The electronic device of claim 1, wherein the processor is configured to cause the electronic device to:
extract a video image of the user from the video stream from the image capturing device; and
generate a first composite video image by overlaying the video image of the user on the second virtual background image.

9. The electronic device of claim 8, further comprising:
one or more output device communicatively coupled to the processor and comprising a display; and
wherein the processor is configured to cause the electronic device to generate and render, via the display, a video communication session window that comprises the first composite video image.

10. The electronic device of claim 8, wherein the processor is configured to cause the electronic device to:
transmit, via the communications subsystem, the first composite video image to the one or more second electronic device that generate and render, via a corresponding display, a video communication session window containing the first composite video image.

11. The electronic device of claim 1, further comprising a display communicatively coupled to the processor, and wherein the processor is configured to cause the electronic device to:
in response to determining that each of the plurality of virtual background images in the memory are being used as a virtual background image by the one or more second electronic device:
generate the second virtual background image via altering one of the plurality of virtual background images by altering, for a select one of the plurality of virtual background images in the memory, at least one image characteristic from a group comprising: (i) color; (ii) horizontal mirroring; and (iii) focus; and
present, via the display, a virtual background selection window containing a selection control and the second virtual background image with an indication that the second virtual background image does not duplicate a virtual background image being used by one of the second electronic devices, the selection control enabling user selection of the second virtual background image.

12. A method comprising:
receiving a video stream from an image capturing device positioned to capture a user of an electronic device during a video communication session;
detecting a virtual background setting for the video communication session selecting a first virtual background image of a plurality of virtual background images; and
in response to determining that a second composite video image received from a second electronic device among one or more second electronic device matches the first virtual background image, triggering a change from the first virtual background image to a second virtual background image that is not being used by any of the one or more second electronic device.

13. The method of claim 12, wherein triggering the change from the first virtual background image to the second virtual background image comprises presenting, via a display, a virtual background selection window containing a recommendation to select the second virtual background image to avoid duplicating use of the first virtual background image and containing a control enabling selection of the second virtual background image by the user via one or more input device.

14. The method of claim 12, wherein triggering the change from the first virtual background image to the second virtual background image comprises:
generating and rendering a virtual background notification window containing a recommendation for the user to select the second virtual background image; and
in response to determining that a change from using the first virtual background image to the second virtual background image has not occurred within a period of time following presentation of the recommendation, automatically changing from the first virtual background image to the second virtual background image.

15. The method of claim 12, further comprising:
receiving, via a communications subsystem of the electronic device from the one or more second electronic device, information indicating use of the first virtual background image for a virtual background image.

16. The method of claim 12, further comprising:
receiving a second composite video image containing a second user image overlayed on the first virtual background image; and
comparing the virtual background image of the received composite video to the plurality of virtual background images to identify use of the first virtual background image by the second user.

17. The method of claim 12, further comprising:
extracting a video image of the user from the video stream; and
generating a first composite video image by overlaying the video image of the user on the second virtual background image;
generating and rendering, via a display, a video communication session window that comprises the first composite video image; and
transmitting, via a communications subsystem of the electronic device, the first composite video image to the one or more second electronic device that generate and render, via a corresponding display, a video communication session window containing the first composite video image.

18. The method of claim 12, further comprising:
in response to determining that each of the plurality of virtual background images in a memory of the electronic device are being used as a virtual background image by the one or more second electronic device:
generating the second virtual background image via altering one of the plurality of virtual background images by altering, for a select one of the plurality of virtual background images in the memory, at least one image characteristic from a group comprising: (i) color; (ii) horizontal mirroring; and (iii) focus; and
presenting, via a display, a virtual background selection window containing a selection control and the second virtual background image with an indication that the second virtual background image does not duplicate a virtual background image being used by one of the second electronic devices, the selection control enabling user selection of the second virtual background image.

19. A computer program product comprising:
a computer readable storage device; and
program code on the computer readable storage device that when executed by a processor associated with an electronic device, the program code is configured to cause the electronic device to provide functionality of:
receiving a video stream from an image capturing device positioned to capture a user of the electronic device during a video communication session;
detecting a virtual background setting for the video communication session selecting a first virtual background image of a plurality of virtual background images; and
in response to determining that a second composite video image received from a second electronic device among one or more second electronic device matches the first virtual background image, triggering a change from the first virtual background image to a second virtual background image that is not being used by any of the one or more second electronic device.

20. The computer program product of claim 19, wherein the program code is further configured to cause the electronic device to provide functionality of:
triggering the change from the first virtual background image to the second virtual background image by presenting, via a display, a virtual background selection window containing a recommendation to select the second virtual background image to avoid duplicating use of the first virtual background image and containing a control enabling selection of the second virtual background image by the user via one or more input device.
